(19) United States
(12) Patent Application Publication
(10) Pub. No.: US 2026/0071986 A1
(43) Pub. Date: Mar. 12, 2026

(54) DEVICE AND METHOD FOR MEASURING INHOMOGENEOUS SURFACES BY MEANS OF ACTIVE LASER THERMOGRAPHY

(71) Applicants: thyssenkrupp Automation Engineering GmbH, Bremen (DE); thyssenkrupp AG, Essen (DE)

(72) Inventor: Robert RANFT, Chemnitz (DE)

(73) Assignees: thyssenkrupp Automation Engineering GmbH, Bremen (DE); thyssenkrupp AG, Essen (DE)

(21) Appl. No.: 18/849,163

(22) PCT Filed: Mar. 21, 2023
(86) PCT No.: PCT/EP2023/057250

§ 371 Date: Sep. 20, 2024

(30) Foreign Application Priority Data
Mar. 28, 2022 (DE) 10 2022 203 006.0

(51) Int. Cl. G01N 25/72

(52) U.S. Cl. CPC G01N 25/72

(57) ABSTRACT

An apparatus for the measurement of inhomogeneous surfaces by means of active laser thermography comprises a laser source, which can emit a laser beam onto a surface to be tested in order to form a measurement area, and an observation device for thermographic observation of the surface to be tested, which is distinguished in that the observation device is further adapted to identify error-inducing surfaces on the surface to be tested, the apparatus moreover comprising a shading device which is adapted to modify the measurement area in such a way that a new measurement area is created while excluding the error-inducing surface. A method for the measurement of inhomogeneous surfaces by means of active laser thermography uses such an apparatus.

The present invention relates to an apparatus for the measurement of inhomogeneous surfaces by means of active laser thermography according to the precharacterizing clause of claim 1 and to a method for the measurement of inhomogeneous surfaces by means of active laser thermography according to the precharacterizing clause of claim 6.

Specimens are tested with the aid of active laser thermography. This measurement methodology, however, is influenced by surfaces that are inhomogeneous in respect of their absorptivity and emissivity for electromagnetic waves. Typically, this means contaminations on the surface to be tested, which are generally caused by preliminary processes. The latter may lead to erroneous measurements due to problematic surfaces. Once contamination has taken place, retesting is possible only by preliminary cleaning of the surfaces to be tested. However, this detrimentally affects the productivity of the testing machine.

This is the contextual basis of the present invention, the object of which is to provide an improved apparatus for the measurement of inhomogeneous surfaces by means of active laser thermography, and in particular to provide an apparatus which prevents, or at least reduces, the problems outlined above. In particular, the intention is to provide an apparatus for the measurement of inhomogeneous surfaces by means of active laser thermography which avoids, or at least reduces, measurement errors and/or enables a higher productivity, or shorter cycle times, for the measurement.

According to the invention, this object is achieved by an apparatus having the characterizing features of claim 1. By virtue of the fact that the observation device B is further adapted to identify error-inducing surfaces on the surface to be tested, the apparatus comprising a shading device A which is adapted to modify the measurement area in such a way that a new measurement area is created while excluding the error-inducing surface, the disadvantages outlined above can be overcome, or at least alleviated. With the aid of the manipulation of the measurement area, particularly in respect of size, geometry, position, etc., the error-inducing regions can be excluded from the measurement. These excluded regions are not taken into account for the further evaluation. The manipulation of the measurement area may take place by mechanical movement of the test head, spot-varying laser optics, mirror systems and/or shutters.

An increase of the testing speed and of the achievable productivity may also be achieved. Since the measurement time is contingent on the component-specific measurement frequency, an increase in the performance is to be expected above all by the acceleration or replacement of manipulation processes. Partial suppression of the measurement area is considered to be acceptable when the region still to be evaluated is large enough so that the features to be tested can be assessed meaningfully.

Further advantageous configurations of the proposed invention result in particular from the features of the dependent claims. The subjects, or features, of the various claims may in principle be combined arbitrarily with one another.

According to one advantageous configuration of the invention, the observation device may comprise an observation means or an observation means and a semitransparent mirror.

According to a further advantageous configuration of the invention, the observation means may comprise a thermal imaging camera or be configured as a thermal imaging camera.

According to a further advantageous configuration of the invention, the shading device may comprise a first movable mirror and a second movable mirror.

According to a further advantageous configuration of the invention, the shading device may comprise a first shutter plate having a shutter plate drive and a second shutter plate having a shutter plate drive.

It is a further object of the present invention to provide an advantageous method for the measurement of inhomogeneous surfaces by means of active laser thermography with an apparatus according to the invention.

According to the invention, this object is achieved by a method having the characterizing features of claim 6.

Further advantageous configurations of the proposed invention result in particular from the features of the dependent claims. The subjects, or features, of the various claims may in principle be combined arbitrarily with one another.

Further features and advantages of the present invention will become clear from the following description of preferred exemplary embodiments with reference to the appended drawings, in which:

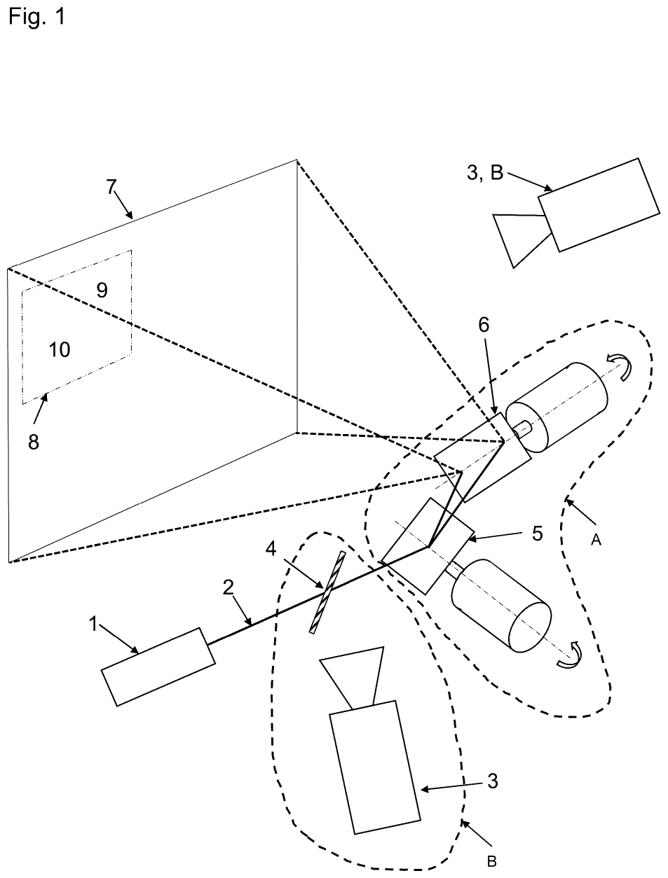

FIG. 1 shows an apparatus according to the invention in a first embodiment;

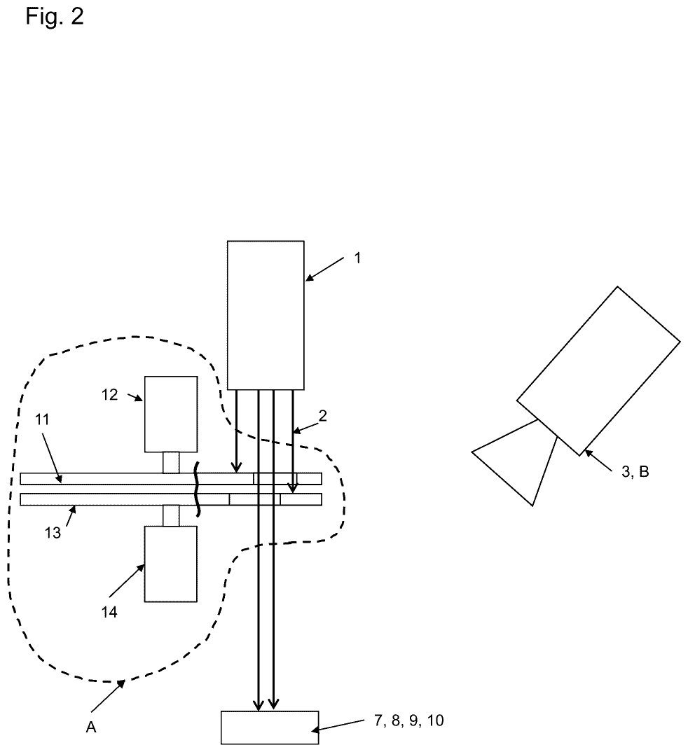

FIG. 2 shows an apparatus according to the invention in a first embodiment.

The following reference signs are used in the drawings:

| A | shading device |
|---|---|
| B | observation device |
| 1 | laser source/laser optics |
| 2 | laser beam |
| 3 | observation means |
| 4 | mirror |
| 5 | (first) movable mirror |
| 6 | (second) movable mirror |
| 7 | working region/surface to be tested |
| 8 | original measurement area |
| 9 | error-inducing surface |
| 10 | newly created measurement area |
| 11 | (first) shutter plate |
| 12 | shutter plate drive for first shutter plate |
| 13 | (second) shutter plate |
| 14 | shutter plate drive for second shutter plate |

Features and details which are described in connection with a method naturally also apply in connection with the apparatus according to the invention and vice versa, so that in respect of the disclosure cross-reference is or may always be made to the individual aspects of the invention. Furthermore, any described method according to the invention may be carried out with the apparatus according to the invention.

The terminology used herein only serves to describe particular embodiments and is not intended to limit the disclosure. As used herein, the singular forms “a/an” and “the” are also intended to construe the plural forms unless the context clearly dictates otherwise. It is also clear that the expressions “has” and/or “having” when used in this description specify the presence of said features, integral numbers, steps, operations, elements and/or components but do not exclude the presence or the addition of one or more other features, integral numbers, steps, operations, elements, components and/or groups thereof. As used herein, the expression “and/or” includes any and all combinations of one or more of the associated listed elements.

Reference is first made to FIG. 1.

An apparatus for the measurement of inhomogeneous surfaces by means of active laser thermography essentially comprises a laser beam source or laser optics 1 which emit a laser beam 2, an observation device B and a shading device A.

The observation device B may comprise an observation means 3 or an observation means 3 and a mirror 4.

The observation means 3 may in particular be a thermal imaging camera.

The shading device A may comprise a first movable mirror 5 and a second movable mirror 6.

Further aspects of the present invention will become clear from the following description of a method for the measurement of inhomogeneous surfaces by means of active laser thermography by the apparatus for the measurement of inhomogeneous surfaces by means of active laser thermography. It is to be understood that only some selected method steps that assist understanding of the method according to the invention are represented here. The method may comprise further steps, or intermediate steps, familiar to a person skilled in the art.

The laser beam 1 emerges from the laser source 1, which has a variable laser spot, and is deflected with the aid of the movable mirrors 5 and 6. The reflected rays impinge on a working region 7. Illumination of a measurement area 8 and parallel observation by the observation device B take place. The observation may take place via the observation means 3 and the semitransparent mirror 4 along the beam path or independently of the mirror system, that is to say only with the observation means 3. The measurement area 8 contains an error-inducing surface 9.

The observation device B, in particular the observation means 3, identifies the error-inducing surface 9, in particular dirt. The information may be transmitted to a suitable data processing unit, which may in turn drive the shading device A. One suitable data processing unit that may be envisioned is a personal computer on which suitable image processing algorithms run.

The measurement area 8 is displaced, in particular by modifying the laser beam width and repositioning the mirrors 5 and 6. The newly created measurement area 10 may be composited by recording a plurality of images.

FIG. 2 depicts an alternative embodiment of the apparatus according to the invention.

The alternative embodiment of the apparatus for the measurement of inhomogeneous surfaces by means of active laser thermography also comprises laser optics 1 from which a laser beam 2 emerges. The shading device A here essentially comprises a first shutter plate 11 having a shutter plate drive 12 and a second shutter plate 13 having a shutter plate drive 14.

Further, the alternative embodiment of the apparatus according to the invention also comprises an observation device B comprising an observation means 3.

Further aspects of the present invention will become clear from the following description of a method for the measurement of inhomogeneous surfaces by means of active laser thermography by the apparatus for the measurement of inhomogeneous surfaces by means of active laser thermography. It is to be understood that only some selected method steps that assist understanding of the method according to the invention are represented here. The method may comprise further steps, or intermediate steps, familiar to a person skilled in the art.

A laser beam 2 emerges from a laser source 1 and impinges on the shutter plates 3 and 4, which have openings. The laser spot thereby created impinges on the surface to be tested 7. This process is observed by the observation device B, in particular the observation means 3. The measurement area contains an error-inducing surface. The shutter plates 3 and 4 are adjusted so that the error-inducing regions are masked by the resulting shutter effect.

The comments made above may be referred to in respect of the configuration of the observation device B, in particular the observation means 3, and in respect of the identification and evaluation of error-inducing surfaces.

It is clear that the embodiments are founded on the basic concept of the invention, namely to provide an apparatus for the measurement of inhomogeneous surfaces by means of active laser thermography comprising the laser optics 1, which can emit a laser beam 2 onto a surface to be tested in order to form a measurement area, and an observation device B for thermographic observation of the surface to be tested, which is distinguished in that the observation device B is further adapted to identify error-inducing surfaces on the surface to be tested, the apparatus comprising a shading device A which is adapted to modify the measurement area in such a way that a new measurement area is created while excluding the error-inducing surface.

1-9. (canceled)

10. An apparatus for the measurement of inhomogeneous surfaces by active laser thermography, comprising:
a laser source, which can emit a laser beam onto a surface to be tested in order to form a measurement area;
an observation device for thermographic observation of the surface to be tested, wherein the observation device is further adapted to identify error-inducing surfaces on the surface to be tested; and
a shading device which is adapted to modify the measurement area in such a way that a new measurement area is created while excluding the error-inducing surface.

11. The apparatus as claimed in claim 10, wherein the observation device comprises an observation means or an observation means and a semitransparent mirror.

12. The apparatus as claimed in claim 11, wherein the observation means comprises a thermal imaging camera or is configured as a thermal imaging camera.

13. The apparatus as claimed in claim 10, wherein the shading device comprises a first movable mirror and a second movable mirror.

14. The apparatus as claimed in claim 10, wherein the shading device comprises a first shutter plate having a shutter plate drive and a second shutter plate having a shutter plate drive.

15. A method for the measurement of inhomogeneous surfaces by active laser thermography with an apparatus as claimed in claim 10, the method comprising:
emitting a laser beam onto a surface to be tested in order to form a measurement area;
observing, by thermographic observation, the surface to be tested;
identifying, by the observation device, error-inducing surfaces on the surface to be tested;
modifying the measurement area by exclusion of a detected error-inducing surface by the shading device; and
continuing the measurement without the error-inducing surface in a newly created measurement area.

16. The method as claimed in claim 15, wherein the modification of the measurement area takes place by displacing the measurement area, by modifying the laser beam width and repositioning the mirrors.

17. The method as claimed in claim 15, wherein the modification of the measurement area takes place by adjusting the shutter plates so that the error-inducing regions are masked by the resulting shutter effect.

18. The method as claimed in claim 15, wherein the newly created measurement area can be composited by recording a plurality of images.
